(19) United States
(12) Patent Application Publication
(10) Pub. No.: US 2018/0089268 A1
(43) Pub. Date: Mar. 29, 2018

(54) METHOD AND APPARATUS FOR OPTIMIZING QUERY IN DATA ENGINE

(71) Applicant: ELECTRONICS AND TELECOMMUNICATIONS RESEARCH INSTITUTE, Daejeon (KR)

(72) Inventors: Myungcheol LEE, Daejeon (KR); ChangSoo KIM, Daejeon (KR); Miyoung LEE, Daejeon (KR)

(73) Assignee: ELECTRONICS AND TELECOMMUNICATIONS RESEARCH INSTITUTE, Daejeon (KR)

(21) Appl. No.: 15/485,801

(22) Filed: Apr. 12, 2017

(30) Foreign Application Priority Data
Sep. 28, 2016 (KR) 10-2016-0125004

(51) Int. Cl. G06F 17/30

(52) U.S. Cl. CPC G06F 17/30463; G06F 17/30454; G06F 17/30563

(57) ABSTRACT

Disclosed herein are a method and an apparatus for optimizing a query in a data engine. A query workload analysis is performed on an input execution plan corresponding to a user query, an intermediate representation is generated for the overall execution plan if a query workload analysis result for the execution plan is an online analytical processing (OLAP) analysis, and the interpretation representation is generated for some of the operators in the overall execution plan if the query workload analysis result is an online transaction processing (OLTP) query. Further, a query executor is acquired and the query executor is to performed, by compiling the intermediate representation with an in-memory machine code.

### CROSS-REFERENCE TO RELATED APPLICATION

This application claims priority to and the benefit of Korean Patent Application No. 10-2016-0125004 filed in the Korean Intellectual Property Office on Sep. 28, 2016, the entire contents of which are incorporated herein by reference.

### STATEMENT REGARDING PRIOR DISCLOSURES BY THE INVENTOR OR A JOINT INVENTOR

Applicant hereby states under 37 CFR 1.77(b)(6) that Myungcheol Lee, Miyoung Lee, and ChangSoo Kim, “A JIT Compilation-based Unified SQL Query Optimization System,” 2016 6th International Conference on IT Convergence and Security (ICITCS 2016), Sep. 26, 2016, is designated as a grace period inventor disclosure. The disclosure: (1) was made one year or less before the effective filing date of the claimed invention; (2) names the inventor or a joint inventor as an author; and (3) does not name additional persons as authors on a printed publication.

### BACKGROUND OF THE INVENTION

### (a) Field of the Invention

The present invention relates to a method and an apparatus for optimizing a query in a data engine.

### (b) Description of the Related Art

Typical corporate decision making is based on results obtained by periodically replicating operational data generated in transaction processing to a data warehouse system and analyzing the data, and therefore online data-based real-time analysis and immediate decision making required for the modern real-time business environment are impossible. In particular, online analytical processing (OLAP) that is a data analysis technology processing complex multi-dimensional queries at a high speed using a multi-dimensional data structure performs pre-aggregation-based processing, and therefore may not promptly respond to queries that are getting more complicated and diverse.

Recently, in order to secure corporate competitiveness based on real-time corporate environment support, analyzing large-scale transactions in real time as soon as the large-scale transactions are generated and using the analyzed results have been required across all industries such as financial abnormal transaction detection, intelligent continuous security attack detection, and online marketing for distributors analyzing and using customer propensity upon payment. For this purpose, a market interest and a demand for a “Hybrid Transaction/Analytical Processing (HTAP)” technology supporting large-scale transaction processing and complex analysis on a single platform” are growing dramatically to be able to provide the real-time analysis and the decision-making environment based on business operation environment of enterprise without movement of data.

A variety of barrier breakthrough techniques are required to realize an all-in-one data engine. Up-to-date database systems have adopted a compiler optimization technique, that is, a just-in-time (JIT) compilation based SQL optimization technique of rewriting a query execution code into a more compressed form, making better use of functions that up-to-date hardware provides to keep data in a register/cache for as long as possible, and using vector processing functions such as a single instruction multiple data (SMID) unit.

However, most systems well support some types of workloads such as OLAP analysis or storage procedures but do not sufficiently consider characteristics of each workload and have a limitation in performing the JIT compilation.

In order to solve the problem that the workload characteristics are different according to the query and the JIT compilation effects are different according to the workload characteristics, a method of optionally applying JIT compilation by automatically identifying a query suitable for the JIT compilation is needed.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for optimizing a query in an all-in-one data engine having advantages of simultaneously supporting an online transaction processing (OLTP) query and an online analytical processing (OLAP) analysis workload.

An exemplary embodiment of the present invention provides an apparatus for optimizing a query in a data engine, including: a query workload analyzer performing a query workload analysis on an execution plan corresponding to a user query to determine whether the corresponding execution plan is an online transaction processing (OLTP) query or an online analytical processing (OLAP) analysis; an intermediate representation generator generating an intermediate representation for the overall execution plan if the query workload analysis result for the execution plan is the OLAP analysis and generating the intermediate representation for some of operators in the overall execution plan if the query workload analysis result is the OLTP query; and a to JIT-based query processing controller acquiring a query executor and performing the query executor, by compiling the intermediate representation provided from the intermediate representation generator with an in-memory machine code.

The query workload analyzer may determine whether the execution plan is the OLTP query or the OLAP analysis based on whether to use an analysis function and an aggregate function and query selectivity.

The query workload analyzer may determine that the execution plan is the OLAP analysis when both of the analysis function and the aggregate function are used, determine that the execution plan is the OLTP query if the predicted query selectivity is larger than a preset threshold when both of the analysis function and the aggregate function are not used, and determine that the execution plan is the OLAP analysis if the query selectivity is equal to or lower than a preset threshold.

The query workload analyzer may determine whether the execution plan is the OLTP query or the OLAP analysis in additional consideration of an input scheme, an execution time, and an execution pattern.

The intermediate representation generator may acquire an execution plan tree by processing the overall execution plan using a pre-compiled interpreter if the query workload analysis result is the OLTP query and check whether the operator is a predetermined operator while traversing each node of the execution plan tree in a top-down scheme, and rewrite the corresponding operator into an intermediate representation at an operator level when the operator is the predetermined operator.

The predetermined operator may be a key relational operation including SORT, JOIN, and GROUP-BY.

The apparatus may further include: an optimization rules executor applying intermediate representation syntax based optimization rules to the intermediate representation provided from the intermediate representation generator to provide the optimized intermediate representation to the JIT based query processing controller; and an optimization rules provider providing an intermediate representation syntax based optimization rules library to the optimization rules executor.

The apparatus may further include: an intermediate representation manager caching the intermediate representation generated from an execution plan of a previous user query and providing the cached intermediate representation to the JIT-based query processing controller when the execution plan corresponding to the previous user query is input.

The query optimization apparatus may be operated in an extended module form for the all-in-one data engine.

Another embodiment of the present invention provides a method for performing, by an apparatus for optimizing a query in an all-in-one data engine, query optimization, including: performing a query workload analysis on an input execution plan corresponding to a user query to determine whether the corresponding execution plan is an OLTP query or an OLAP analysis; generating an intermediate representation for the overall execution plan if the query workload analysis result for the execution plan is the OLAP analysis and generating the intermediate representation for some of operators in the overall to execution plan if the query workload analysis result is the OLTP query; and acquiring a query executor and performing a query executor, by compiling the intermediate representation with an in-memory machine code.

In the determining, it may be determined whether the execution plan is the OLTP query or the OLAP analysis based on whether to use an analysis function and an aggregate function and query selectivity.

The determining may include: determining whether both of an analysis function and an aggregate function are used; determining that the execution plan is the OLAP analysis when both of the analysis function and the aggregate function are used; predicting query selectivity when both of the analysis function and the aggregate function are not used and comparing the predicted query selectivity with a preset threshold; determining that the execution plan is the OLTP query if the query selectivity is larger than the preset threshold; and determining that the execution plan is the OLAP analysis if the query selectivity is equal to or less than the preset threshold.

The generating of the intermediate representation may include: processing the overall execution plan using a pre-compiled interpreter to acquire an execution plan tree if the query workload analysis result is the OLTP query; checking whether the operator is a predetermined operator while traversing each node of the execution plan tree in a top-down scheme; and rewriting the corresponding operator into the intermediate representation at an operator level when the operator is the predetermined operator.

The predetermined operator may be a key relational operation including SORT, JOIN, and GROUP-BY.

The method may further include: after the generating of the intermediate representation, generating the optimized intermediate representation by applying an intermediate representation syntax based optimization rule to the intermediate representation.

The method may further include: caching the intermediate representation generated from an execution plan of a previous user query. The generating of the intermediate representation may further include using the cached intermediate representation when the user query is a previous user query corresponding to the cached intermediate representation.

### BRIEF DESCRIPTION OF THE DRAWINGS

FIG. 1 is a diagram illustrating an all-in-one data engine.

FIG. 2 is a diagram illustrating an example of a user SQL query to be optimized and an execution plan corresponding to the user SQL query according to an exemplary embodiment of the present invention.

FIG. 3 is a diagram illustrating an example of an intermediate representation generated from the execution plan of FIG. 2 for JIT compilation based query optimization according to an exemplary embodiment of the present invention.

FIG. 4 is a diagram illustrating an example in which optional JIT compilation based query optimization is applied at an execution plan level or an operator level, according to an exemplary embodiment of the present invention.

FIG. 5 is a diagram illustrating a structure of an apparatus for optimizing a query using optional JIT compilation according to an exemplary embodiment of the present invention.

FIG. 6 is a flowchart illustrating a query optimization method using optional JIT compilation according to an exemplary embodiment of the present invention.

FIG. 7 is a configuration diagram of another apparatus for optimizing a query according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, “comprising” any components will be understood to imply the inclusion of other elements rather than the exclusion of any other elements.

In order to realize an all-in-one data engine (hybrid transaction/analytical processing (HTAP)), various barrier breakthrough technologies are required: 1) In-memory data management technology for large-scale transaction and analysis data; 2) High performance query processing technology by maximizing parallelism of up-to-date hardware (e.g., superscalar multi-core/processor, manicore, non-uniform access memory (NUMA) structure, etc.) for large-scale data and overcoming a memory barrier 3) Workload awareness based optional optimization technology for maximizing performance while ruling out interference between queries having different workloads (e.g., online transaction processing (OLTP) query, online analytical processing (OLAP) analysis, storage procedure, etc.) are sequentially required.

In terms of the in-memory data management technology, the existing disk base data base management systems (DBMSs) are being changed to an in-memory DBMS to be able to use a fast access function of a dynamic random access memory (DRAM) while lowering the price of the DRAMs. However, most in-memory DBMSs use pre-compiled interpreter based executors to perform query processing with a traditional Volcano iterator model and tuple-at-a-time model.

In the Volcano based iterator model, a pre-compiled interpreter based query executor visits each operator node while traversing a tree of an execution plan generated from a structured query language (SQL) query in a top-down scheme and processes a corresponding operator to generate a result tuple one at a time until sufficient results are generated, thereby performing the query processing in such a manner that the results are continuously uploaded from bottom to top. The iterator model based query processing is very simple and is easy to apply to any combination of operators.

However, the iterator model based query processing has a limitation in performance in spite of using the latest high parallel hardware. The reason is that it is difficult to use pipeline processing that the latest central processing unit (CPU) provides and is insufficient to use locality of a register/cache due to a number of function calls seen in the iterator model, processing in one tuple unit, etc. and it is difficult to get performance above a memory access speed due to a reduction in branch prediction accuracy, etc.

As a result, up-to-date database systems such as HIQUE, HyPer, MonetDB, Hekaton, Impala, and LegoBase have adopted a compiler optimization technique, that is, a just-in-time (JIT) compilation based SQL optimization technique of converting a query execution code into a more compressed form, making better use of functions that up-to-date hardware provides to keep data in a register/cache for as long as possible, and using vector processing functions such as a single instruction multiple data (SMID) unit.

However, most systems well support some types of workloads such as OLAP analysis or storage procedures but do not sufficiently consider characteristics of each workload and have a limitation in performing the JIT compilation. For example, the Hekaton supports the JIT compilation only for the storage procedure and the HyPer executes the JIT compilation regardless of the OLAP/OLTP and therefore does not support the JIT compilation reflecting characteristics of an OLTP query and an OLAP analysis workload.

As a result of performing the JIT compilation, the performance of the compiled query executor is improved but it takes a little time to perform the JIT compilation. Therefore, it has been known that the JIT compilation accesses most records to perform an analysis and is suitable for an OLAP analysis having characteristics performed for a long time and the storage procedure that is executed several times if the compilation is executed once and therefore does not take a compilation time into consideration as being important but is not suitable for the OLTP query performing storage/retrieval/change by accessing only some records.

In addition, the OLAP analysis makes the overall query execution time long and does not take the JIT compilation time into consideration as an important factor, and therefore has an advantage of processing the overall query execution plan by performing the JIT compilation on the overall query execution plan, but the OLTP query basically makes the entire execution time short but has characteristics to dramatically increase the execution time at the time of the use of some of key operators such as JOIN, SORT, and GROUP-BY, and takes the JIT compilation time into consideration as an important factor. Therefore, the OLTP query performs JIT compilation on only some of the key operators rather than performing JIT compilation on the overall execution plan to integrate the main operators into the operator processing of the existing interpreter model, thereby showing better performance.

However, there is no criterion for determining what query is an OLTP type query and what query is an OLAP type analysis. Therefore, it is reality that even a criterion for determining when to apply the JIT compilation is not clearly defined. As a result, in order to solve the problem that the workload characteristics are different according to the query and the JIT compilation effects are different according to the workload characteristics, a method of optionally applying JIT compilation by automatically identifying a query suitable for the JIT compilation is needed.

An exemplary embodiment of the present invention is to provide a method and an apparatus for optimizing a query in an all-in-one data engine capable of simultaneously supporting an OLTP query and an OLAP analysis workload. More specifically, the exemplary embodiment of the present invention is to provide a method and an apparatus for optimizing a query which apply a JIT compilation technique to generate and execute a query executor compiled with an optimal machine code in order to optionally JIT-compile and execute a query execution plan or some operators with the machine code based on an OLTP query and OLAP analysis workload awareness, in an all-in-one data engine for overcoming a database query performance limitation caused by processing a user query using an interpreter scheme based on Volcano style iteration.

The method for optimizing a query according to an embodiment of the present invention may be particularly useful when being applied to the all-in-one data engine supporting both the OLTP query and the OLAP analysis workload while providing an in-memory data management function, but is not limited in forms of disk data management or in-memory data management, a row-based or column-based data storage structure, etc. and may be widely applied to a general type database system.

Hereinafter, a method and an apparatus for optimizing a query according to an embodiment of the present invention will be described with reference to the accompanying drawings.

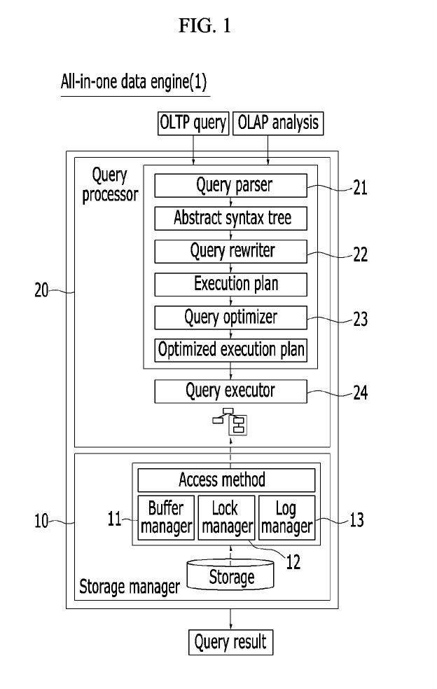

FIG. 1 is a diagram illustrating an all-in-one data engine.

As illustrated in FIG. 1, an all-in-one data engine 1 largely includes a storage manager 10 and a query processor 20.

The storage manager 10 provides a management and access method for data managed on a disk or memory to the query processor 20, in which the to query processor 20 uses the management and access method provided by the storage manager 10 to process a query input by a user and provide the processed results to a user

The storage manager 10 includes a buffer manager 11 for efficiently loading data stored in a disk or an in-memory, a lock manager 12 for controlling a multiple access to the data, and a log manager 13 for transaction management and transfers data access methods for the user to the query processor 20.

The query processor 20 includes a query parser 21 for parsing a user query for an OLTP query or an OLAP analysis, a query rewriter 22 for rewriting an abstract syntax tree that is a parsing result into an executable execution plan, a query optimizer 23 for rewriting the execution plan into an optimized form, and an interpreted executor 24 for performing query processing while traversing the execution plan having the optimized tree form in a top-down scheme and generating a query result in a bottom-up scheme and transferring the generated query result.

The structure of the all-in-one data engine 1 illustrated in FIG. 1 is a structure that typical DMBSs have commonly adopt.

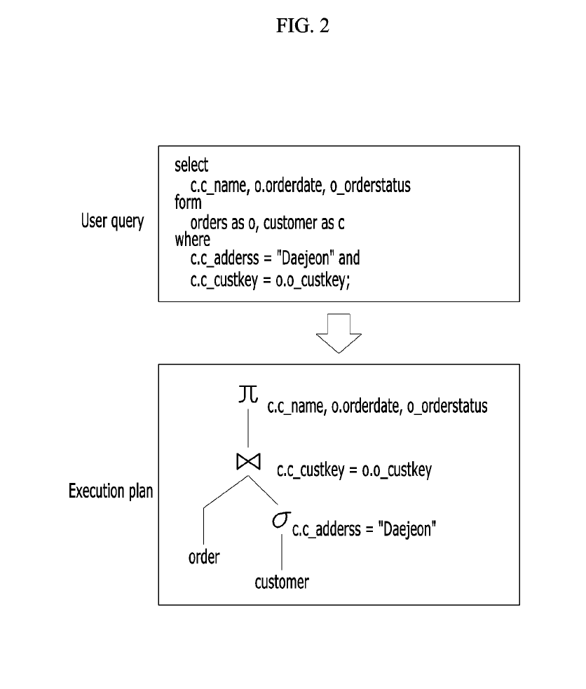

FIG. 2 is a diagram illustrating an example of a user SQL query to be optimized and an execution plan corresponding to the user SQL query according to an exemplary embodiment of the present invention.

By applying the user SQL query and the execution plan illustrated in FIG. 2 to the all-in-one data engine illustrated in FIG. 1, the interpreter based query executor of the data engine calls functions (e.g., join ( ) function in case of a join node) performing processing according to types (kinds of operators) of each to node representing an operator while traversing from a root node to a terminal node according to the execution plan illustrated in FIG. 2. Each function sequentially performs functions of a lower node to sequentially receives the results to generate the results of the corresponding node. Therefore, the processing method generates a plurality of function calls and has a difficulty in using a pipeline processing function that an up-to-date CPU provides, a register/cache or the like and may not perform parallel processing due to a single tuple unit processing

Therefore, due to the interpreter based query processing, the database systems has a difficulty in improving performance in spite of using up-to-date hardware.

According to the exemplary embodiment of the present invention, the execution plan is rewritten into an intermediate representation (IR) form to be used.

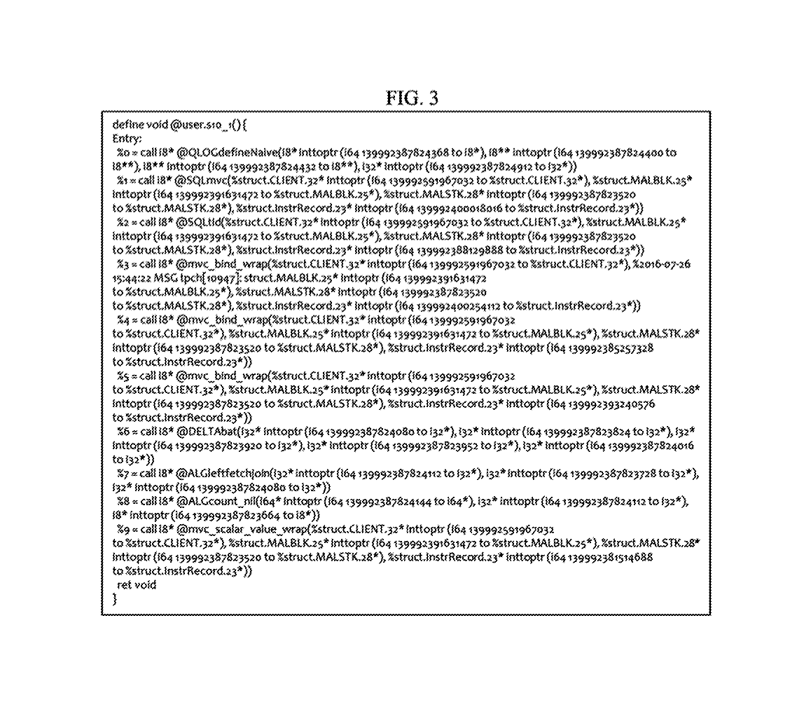

FIG. 3 is a diagram illustrating an example of an intermediate representation generated from the execution plan of FIG. 2 for JIT compilation based query optimization according to an exemplary embodiment of the present invention.

The execution plan represented in the intermediate representation form consists of a number of low-level operator function calls. Each operator function has already been rewritten into the intermediate representation form to be managed, and the execution plan may connected with an execution plan according to an optimization method while being rewritten into the intermediate representation so that comprehensive optimization may be performed.

The intermediate representation according to the exemplary embodiment of the present invention is represented using an intermediate representation syntax of a low level virtual machine (LLVM) that is an open source project so that various SQL queries may be represented in independent representations of a low-level platform and various optimizations may be applied, but is not limited thereto. The intermediate representation is rewritten into an optimized intermediate representation when the optimization is applied and finally rewritten into a platform-dependent machine code to be executed.

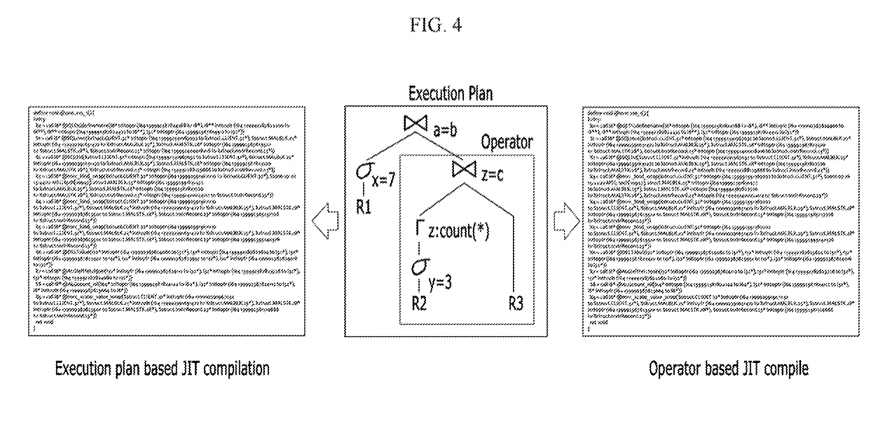

FIG. 4 is a diagram illustrating an example in which optional JIT compilation based query optimization is applied at an execution plan level or an operator level, according to an exemplary embodiment of the present invention.

The SQL query may also be executed by JIT-compiling the overall SQL execution plan based on the intermediate representation and by JIT-compiling the SQL execution plan in a key relationship operator unit using a pre-complied interpreter based SQL query executor in a relational tree based SQL execution plan state. When the overall execution plan is JIT-compiled and the SQL query is executed, the query processing ends as soon as the query result is provided to a user. When the excution plan is JIT-compiled at the operator level to excute the SQL query, the result returns to the interpreter based query executor and then the interpreter based query executor executes the query processing on the next operator node.

According to the exemplary embodiment of the present invention, the optional JIT compilation based query optimization may be applied to the all-in-one data engine.

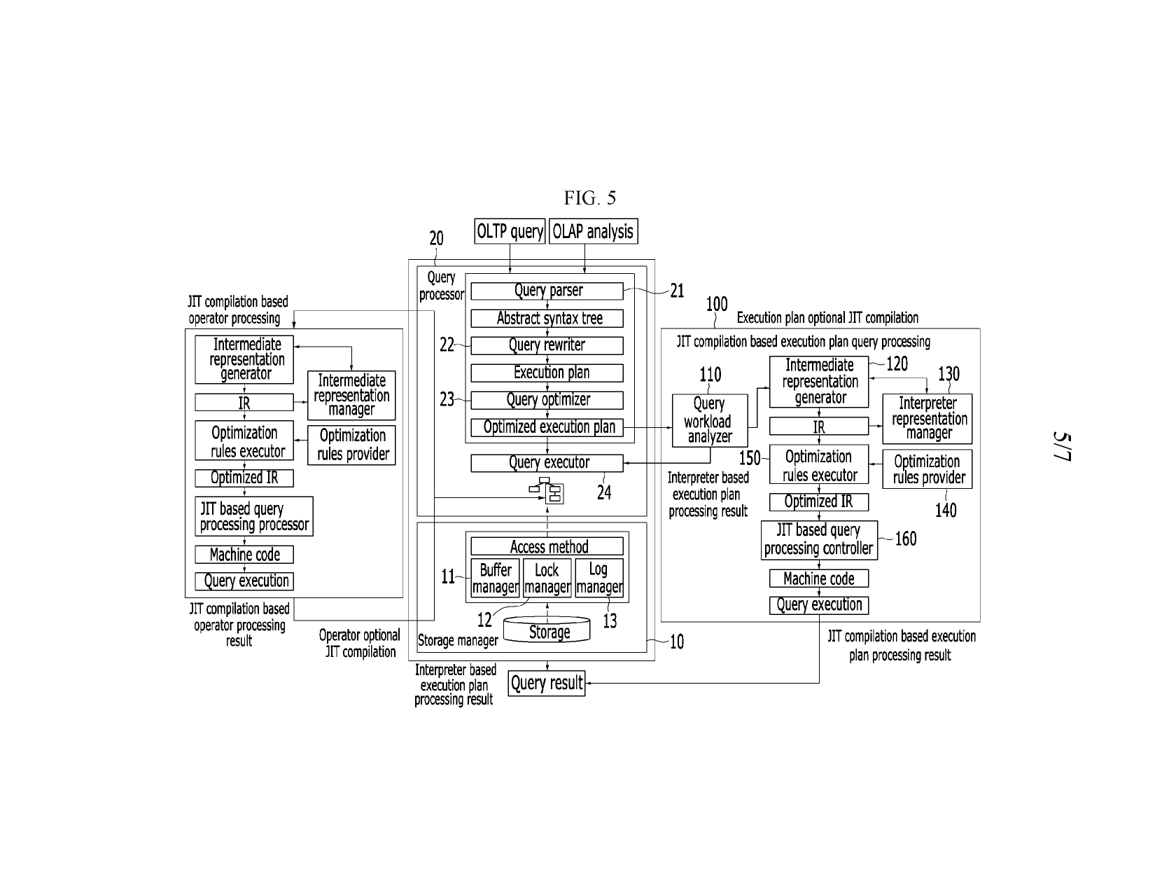

FIG. 5 is a diagram illustrating a structure of an apparatus for optimizing a query using optional JIT compilation according to an exemplary embodiment of the present invention. Specifically, FIG. 5 is a diagram illustrating a structure in which an apparatus for optimizing a query is applied to the all-in-one data engine using optional JIT compilation according to the exemplary embodiment of the present invention.

As illustrated in FIG. 5, an apparatus 100 for optimizing a query using optional JIT compilation according to an exemplary embodiment of the present invention includes a query workload analyzer 110, an intermediate representation generator (IR generator) 120, an intermediate representation manager 130, an optimization rules provider 140, an optimization rules executor (IR optimizer) 150, and a JIT based query processing controller 160.

The apparatus 100 for optimizing a query is operated in an extended module form for the all-in-one data engine illustrated in FIG. 1. Accordingly, the query optimization using the optional JIT compilation according to the exemplary embodiment of the present invention may be widely applied to a general DBMS structure

The query workload analyzer 110 determines what query is optimal for JIT compilation based execution for a user's ad-hoc input query. The query workload analyzer 110 determines that the corresponding query is optimal for the JIT compilation based execution based on a predetermined determination criterion considering the JIT compilation time, in the case of the OLAP analysis rather than the case of the OLTP query. According to the determination based on the predetermined determination criterion, it is determined that the execution to plan corresponding to the query is the OLAP analysis, that is, the JIT compilation is efficient if, for example, the ad-hoc input query uses an analysis/aggregate function or query selectivity is low and it is determined that the OLTP query other than that, that is, the JIT compilation is inefficient.

The intermediate representation generator 120 generates the intermediate representation (e.g., LLVM intermediate representation) from the SQL query execution plan. The intermediate representation generator 120 generates the intermediate representation for the overall SQL execution plan in the case of the OLAP analysis and the storage procedure and generates the intermediate representation for some of key relational operators (SORT, JOIN, GROUP-BY, etc.) from the overall SQL execution plan in the case of the OLTP query.

The intermediate representation manager 130 caches and provides the intermediate expression generated from the previous SQL query. Accordingly, in the case of frequently executed queries, it is possible to shorten time taken to generate the intermediate representation. In addition, the intermediate representation manager 130 provides an appropriate cache entry control policy to control when/what queries are to be managed and exported, taking into account a limited memory space for managing the compiled queries. Since the execution time is short in the case of the OLTP query, reducing the intermediate representation generation time helps to shorten the overall execution time.

The optimization rules provider 140 provides an optimization rules library based on the meaning of the SQL query and the intermediate representation syntax. The SQL query semantic based key optimization rules support push to based data transfer between operators, redundant materialization elimination, data layout conversion, optimization of join order, and intermediate code-based transaction processing basic operation optimization by concurrency control level, or the like. The intermediate representation syntax based optimization rules include redundant code elimination, unnecessary code elimination, function inline, loop merge, SIMD utilization optimization, etc. Some intermediate representation syntax based optimization rules are provided, by for example, utilizing optimization rules provided by the LLVM.

The optimization rules executor 150 applies macro optimization of various execution plan levels and an operator, and micro optimization of the execution plan and operator integration level to the intermediate representation. As the optimization rules applied, the SQL query semantic based optimization rules and the intermediate representation syntax based optimization rules provided by the optimization rules provider 140 are optionally applied. The optimization rules executor 150 provides an optimization module pipeline function so that optimization rules frequently used together may be applied in a batch, and supports a system-provided built-in pipeline and a user-defined pipeline configuration function.

The JIT based query processing controller 160 compiles the intermediate representation with the in-memory machine code and performs the compiled query executor generated in the in-memory machine code form. The compiled query executor is executed in a separate thread or function call form within a process space like a key query processing thread.

In order to support query optimization using the OLTP query and the OLAP analysis workload awareness based optional JIT compilation, the exemplary embodiment of the present invention provides a query workload analysis standard as shown in Table 1.

TABLE 1

| Analysis criterion | OLTP query | OLAP analysis |
|---|---|---|
| Use of analysis | X | ◯ |
| function(window, over, | | |
| rank etc.) | | |
| Use of aggregate | ◯ | ◯ |
| function(sum, min, max | | |
| etc.) | | |
| Input scheme | Mainly simple | ad-hoc query + |
| | ad-hoc query | storage |
| | | procedure call |
| Execution time | Very short | Normal long |
| Execution pattern | Frequent performance | Periodic repetition |
| | of the same query at | in hour/day unit |
| | a short time | |
| Query selectivity (Inverse | High | Low |
| of ration of the number of | (The number of | (The number of |
| accessed/returning records | results is small) | results is many) |
| to a total number of records | | |
| depending on conditional | | |
| sentence of where clause | | |

The query workload analysis criterion is performed by being comprehensively computed in the query workload analyzer module 110.

The following Table 2 shows the JIT compilation behavior. Specifically, the following Table 2 shows the JIT compilation behavior optionally applied to the OLTP query and the OLAP analysis workload according to the query workload analysis result of comprehensively calculating the query workload analysis criterionDeletedTexts in the query workload analyzer 100.

TABLE 2

| JIT | | |
|---|---|---|
| compilation | | |
| behavior | OLTP query | OLAP analysis |
| JIT | Non-apply JIT compilation to | Apply JIT compilation |
| compilation | the overall plan | to the overall |
| application | Apply JIT compilation in case of | execution plan |
| range | some of key operators (SORT, | |
| | JOIN, GROUP-BY, etc.) | |
| Optimization | Apply intermediate | Apply intermediate |
| rules | representation based optimi- | representation based |
| applied | zation rules to shorten | optimization rules to |
| | execution time of OLTP query | shorten execution time |
| | in consideration of utilization | of OLTP analysis in |
| | of OLTP query and workload | consideration of |
| | characteristics | utilization of OLTP |
| | | analysis and workload |
| | | characteristics |
| Query cache | Manage JIT-compiled intermediate | Reduce cache |
| | representation in cache, if possible, | necessity (Low) |
| | to shorten JIT compilation time | |

Hereinafter, the query optimization using the OLTP query and the OLAP analysis workload awareness based optional JIT compilation according to an embodiment of the present invention will be described.

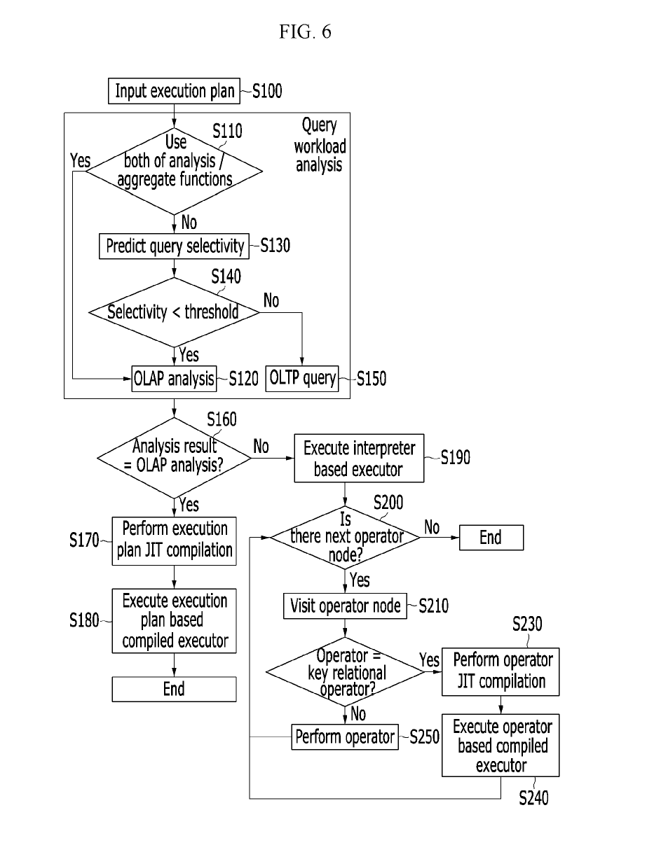

FIG. 6 is a flowchart illustrating a query optimization method using optional JIT compilation according to an exemplary embodiment of the present invention.

As illustrated FIG. 6, when the execution plan is input (S100), the apparatus 100 for optimizing a query according to the exemplary embodiment of the present invention performs the query workload analysis on the input execution plan to determine whether the corresponding execution plan is the OLTP query or the OLAP analysis. Specifically, when all the analysis/aggregate functions are used, it is determined that the execution plan is the OLAP analysis (S110, S120). If all the analysis/aggregate functions are not used, the query selectivity is predicted (S130), the predicted query selectivity is compared with a preset threshold (S140), and if the query selectivity is equal to or less than the threshold, the execution plan is determined as the OLAP analysis (S120). On the other hand, if the query selectivity is equal to or greater than the threshold value, it is determined that the execution plan is the OLTP query (S150). At this point, the threshold to be used may be variably set by the experiment. Meanwhile, upon the analysis of the query workload for the to execution plan, it may be determined whether the corresponding execution plan is the OLTP query or the OLAP analysis based on the query workload analysis criterion as shown in Table 1.

If the query workload analysis result of the execution plan is the OLAP analysis (S160), the overall execution plan is rewritten into the intermediate representation basis, and then JIT-compiles it with the machine code through the optimization process (S170), and the compiled query executor is generated and executed (S180).

On the other hand, if the query workload analysis result for the execution plan is the OLTP query, the overall execution plan is basically processed using the pre-compiled interpreter (S190). While transversing each node of the execution plan tree in the top-down scheme it checks whether the operator is the key relational operators (SORT, JOIN, GROUP-BY, etc.) (S200 to S220). As the check result, the operator is JIT-compiled if the operator is the key relational operator. That is, the corresponding operator is rewritten into the intermediate representation from the operator level, and then is subjected to the optimization process to be JIT-compiled with the machine code (S230). Thereafter, the compiled operator based executor is performed (S240). The execution result is transferred to an upper operator node to be used for the next operation processing. Meanwhile, as the check result, if the operator is not the key relational operator, the corresponding operator is performed (S250), and then the above process is repeated according to the presence or absence of the next operator

According to the exemplary embodiment of the present invention as to described above, in the all-in-one data engine that determines the JIT compilation according to each workload in consideration of the OLTP query and the OLAP analysis workload characteristics and performs the optimization according to each workload characteristic to support both of the OLTP query and the OLAP analysis workload, the high-parallel pipelined processing and high-speed register/memory provided by the up-to-date hardware may be used to improve the overall query processing performance of the all-in-one data engine.

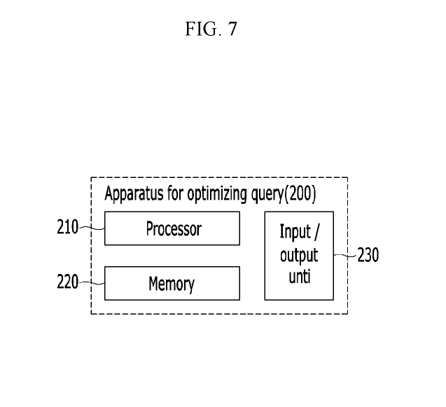

FIG. 7 is a configuration diagram of another apparatus for optimizing a query according to an exemplary embodiment of the present invention.

As illustrated in FIG. 7, an apparatus 200 for optimizing a query according to the exemplary embodiment of the present invention includes a processor 210, a memory 220, and an input/output unit 230. The processor 210 may be configured to implement the methods described based on FIGS. 2 to 6. For example, the processor 210 may be configured to perform the functions of the query workload analyzer, the intermediate representation manager, the optimization rules provider, the optimization rules executor, and the JIT based query processing controller.

The memory 220 is connected to the processor 210 and stores various information associated with an operation of the processor 210. The memory may store instructions for operations to be executed by the processor 210 or load instructions from a storage apparatus (not illustrated) and temporarily store the loaded instructions. Further, the memory 220 may be configured to perform, for example, a function of a query processing data in-memory storage unit. The processor 210 may execute the instructions stored or loaded in the memory 220. The processor 210 and the memory 220 are connected to each other through a bus (not illustrated) and an input/output interface (not illustrated) may also be connected to the bus.

The input/output unit 230 is configured to output the processed results of the processor 210 and input an data to the processor 210.

According to an exemplary embodiment of the present invention, it is possible to overcome the limitation in performance improvement due to the interpreter based query processing in the existing database system and simultaneously and efficiently support the OLTP query and the OLAP analysis, by performing the optional JIT compilation of the execution plan or the operator level based on the OLTP query and the OLAP analysis workload awareness in the all-in-one data engine supporting the query optimization using the JIT compilation.

In addition, it is possible to improve the query processing performance by optimally applying the JIT compilation to both of the OLTP query and the OLAP analysis having different workload characteristics and JIT compilation effects in the all-in-one data engine supporting both of the OLTP query and the OLAP analysis according to the optional query optimization.

The exemplary embodiments of the present invention are not implemented only by the apparatus and/or method as described above, but may be implemented by programs realizing the functions corresponding to the configuration of the exemplary embodiments of the present invention or a recording medium recorded with the programs, which may be readily to implemented by a person having ordinary skill in the art to which the present invention pertains from the description of the foregoing exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for optimizing a query in a data engine, comprising:
a query workload analyzer performing a query workload analysis on an execution plan corresponding to a user query to determine whether the corresponding execution plan is an online transaction processing (OLTP) query or an online analytical processing (OLAP) analysis;
an intermediate representation generator generating an intermediate representation for the overall execution plan if the query workload analysis result for the execution plan is the OLAP analysis and generating the intermediate representation for some of operators in the overall execution plan if the query workload analysis result is the OLTP query; and
a JIT-based query processing controller acquiring a query executor and performing the query executor, by compiling the intermediate representation provided from the intermediate representation generator with an in-memory machine code.

2. The apparatus of claim 1, wherein:
the query workload analyzer determines whether the execution plan is the OLTP query or the OLAP analysis based on whether to use an analysis function and an aggregate function and query selectivity.

3. The apparatus of claim 2, wherein:
the query workload analyzer determines that the execution plan is the OLAP analysis when both of the analysis function and the aggregate function are used, determines that the execution plan is the OLTP query if the predicted query selectivity is larger than a preset threshold when both of the analysis function and the aggregate function are not used, and determines that the execution plan is the OLAP analysis if the query selectivity is equal to or lower than a preset threshold.

4. The apparatus of claim 2, wherein:
the query workload analyzer determines whether the execution plan is the OLTP query or the OLAP analysis in additional consideration of an input scheme, an execution time, and an execution pattern.

5. The apparatus of claim 1, wherein:
the intermediate representation generator acquires an execution plan tree by processing the overall execution plan using a pre-compiled interpreter if the query workload analysis result is the OLTP query and checks whether the operator is a predetermined operator while traversing each node of the execution plan tree in a top-down scheme, and rewrites the corresponding operator into an intermediate representation at an operator level when the operator is the predetermined operator.

6. The apparatus of claim 5, wherein:
the predetermined operator is a key relational operation including SORT, JOIN, and GROUP-BY.

7. The apparatus of claim 1, further comprising:
an optimization rules executor applying intermediate representation syntax based optimization rules to the intermediate representation provided from the intermediate representation generator to provide the optimized intermediate representation to the JIT based query processing controller; and
an optimization rules provider providing an intermediate representation syntax based optimization rules library to the optimization rules executor.

8. The apparatus of claim 1, further comprising:
an intermediate representation manager caching the intermediate representation generated from an execution plan of a previous user query and providing the cached intermediate representation to the JIT-based query processing controller when the execution plan corresponding to the previous user query is input.

9. The apparatus of claim 1, wherein:
the query optimization apparatus is operated in an extended module form for the all-in-one data engine.

10. A method for performing, by an apparatus for optimizing a query in an all-in-one data engine, query optimization, comprising:
performing a query workload analysis on an input execution plan corresponding to a user query to determine whether the corresponding execution plan is an OLTP query or an OLAP analysis;
generating an intermediate representation for the overall execution plan if the query workload analysis result for the execution plan is the OLAP analysis and generating the intermediate representation for some of operators in the overall execution plan if the query workload analysis result is the OLTP query; and
acquiring a query executor and performing the query executor, by compiling the intermediate representation with an in-memory machine code.

11. The method of claim 10, wherein:
in the determining, it is determined whether the execution plan is the OLTP query or the OLAP analysis based on whether to use an analysis function and an aggregate function and query selectivity.

12. The method of claim 11, wherein:
the determining includes:
determining whether both of an analysis function and an aggregate function are used;
determining that the execution plan is the OLAP analysis when both of the analysis function and the aggregate function are used;
predicting query selectivity when both of the analysis function and the aggregate function are not used and comparing the predicted query selectivity with a preset threshold;
determining that the execution plan is the OLTP query if the query selectivity is larger than the preset threshold; and
determining that the execution plan is the OLAP analysis if the query selectivity is equal to or less than the preset threshold.

13. The method of claim 10, wherein:
the generating of the intermediate representation includes:
processing the overall execution plan using a pre-compiled interpreter to acquire an execution plan tree if the query workload analysis result is the OLTP query;
checking whether the operator is a predetermined operator while traversing each node of the execution plan tree in a top-down scheme; and
rewriting the corresponding operator into the intermediate representation at an operator level when the operator is the predetermined operator.

14. The method of claim 13, wherein:
the predetermined operator is a key relational operation including SORT, JOIN, and GROUP-BY.

15. The method of claim 10, further comprising:
after the generating of the intermediate representation,
generating the optimized intermediate representation by applying an intermediate representation syntax based optimization rule to the intermediate representation.

16. The method of claim 10, further comprising:
caching the intermediate representation generated from an execution plan of a previous user query,
wherein the generating of the intermediate representation further includes using the cached intermediate representation when the user query is a previous user query corresponding to the cached intermediate representation.
